(19) United States
(12) Patent Application Publication
(10) Pub. No.: US 2026/0261664 A1
(43) Pub. Date: Sep. 3, 2026

(54) IDENTIFICATION OF POST-FILTER INPUT PICTURES

(71) Applicant: Telefonaktiebolaget LM Ericsson (publ), Stockholm (SE)

(72) Inventors: Rickard SJÖBERG, Stockholm (SE); Martin PETTERSSON, Vallentuna (SE); Mitra DAMGHANIAN, Upplands-Bro (SE)

(73) Assignee: Telefonaktiebolaget LM Ericsson (publ), Stockholm (SE)

(21) Appl. No.: 19/474,173

(22) PCT Filed: Apr. 12, 2024
(86) PCT No.: PCT/EP2024/059946

§ 371 Date: Oct. 9, 2025

Related U.S. Application Data
(60) Provisional application No. 63/458,964, filed on Apr. 13, 2023.

(51) Int. Cl. H04N 19/117; H04N 19/169; H04N 19/172; H04N 19/70; H04N 19/82; H04N 19/85

(52) U.S. Cl. CPC H04N 19/117; H04N 19/172; H04N 19/188; H04N 19/70; H04N 19/82; H04N 19/85

(57) ABSTRACT

A method performed by a receiving device. The method includes receiving a bitstream comprising a first set of coded pictures. The method also includes decoding the first set of coded pictures to produce a set of decoded output pictures, wherein i) each decoded output picture in the set of decoded output pictures has a unique picture identifier value and ii) the set of decoded output pictures comprises a current picture and a set of preceding pictures, where each preceding picture in the set of preceding pictures precedes, in an output order, the current picture. The method also includes obtaining from the bitstream a message associated with the current picture, wherein i) the message relates to a post-filtering of a set of two or more intended input pictures, where the set of intended input pictures comprises the current picture (in one embodiment, all intended input pictures other than the current picture precede the current picture in output order) and ii) the message comprises information for enabling the receiver to determine whether or not the receiver has all of the intended input pictures (e.g., determine whether or not the set of decoded output pictures comprises all of the intended input pictures).

### TECHNICAL FIELD

Disclosed are embodiments related to post-filtering of decoded pictures.

### BACKGROUND

### Video and Picture

Many video codecs, such as Versatile Video Coding (VVC) and its predecessor High Efficiency Video Coding (HEVC), are block-based video codecs. These codecs utilize both temporal and spatial prediction and are similar in many aspects. Spatial prediction is achieved using intra (I) prediction from within a current picture (i.e., the picture currently being encoded). Temporal prediction is achieved using uni-directional (P) or bi-directional inter (B) prediction on the block level from previously decoded reference pictures.

In the encoder, the difference between the original pixel data and the predicted pixel data, referred to as the residual, is transformed into the frequency domain, quantized and then entropy coded before transmitted together with necessary prediction parameters such as prediction mode and motion vectors, also entropy coded. The decoder performs entropy decoding, inverse quantization, and inverse transformation to obtain the residual, and then adds the residual to an intra or inter prediction to reconstruct a picture.

### NAL Units

Both VVC and HEVC define a Network Abstraction Layer (NAL). All the data, i.e. both Video Coding Layer (VCL) or non-VCL data in HEVC and VVC is encapsulated in NAL units. A VCL NAL unit contains data that represents picture sample values. A non-VCL NAL unit contains additional associated data such as parameter sets and supplemental enhancement information (SEI) messages. The NAL unit in VVC and HEVC begins with a header called the NAL unit header. The syntax for the NAL unit header for HEVC starts with a forbidden_zero_bit that shall always be equal to 0 to prevent start code emulations. Without it, some MPEG systems might confuse the HEVC video bitstream with other data, but the 0 bit in the NAL unit header makes all possible HEVC bitstreams uniquely identifiable as HEVC bitstreams. The NAL unit header in VVC is very similar to the one in HEVC but uses 1 bit less for the nal_unit_type and instead reserves this bit for future use. The nal_unit_type, nuh_layer_id and nuh_temporal_id plus 1 code words specify the NAL unit type of the NAL unit that identifies what type of data is carried in the NAL unit, the scalability layer ID and the temporal layer ID for which the NAL unit belongs to. The NAL unit type indicates and specifies how the NAL unit should be parsed and decoded. The rest of the bytes of the NAL unit is payload of the type indicated by the NAL unit type. A bitstream consists of a series of concatenated NAL units.

A decoder or bitstream parser can conclude how the NAL unit should be handled, e.g., parsed and decoded, after looking at the NAL unit header. The rest of the bytes of the NAL unit is payload of the type indicated by the NAL unit type. All VVC or HEVC bitstreams consist of a series of concatenated NAL units.

The decoding order is the order in which NAL units shall be decoded, which is the same as the order of the NAL units within the bitstream. The decoding order may be different from the output order, which is the order in which decoded pictures are to be output, such as for display, by the decoder.

### Layers and Scalability

The value of the nuh_layer_id syntax element in the NAL unit header specifies the layer ID to which the NAL unit belongs to.

A layer access unit in VVC is defined as a set of NAL units for which the VCL NAL units all have a particular value of nuh_layer_id, that are associated with each other according to a specified classification rule, that are consecutive in decoding order, and that contain exactly one coded picture.

A coded layer video sequence (CLVS) in the VVC is defined as a sequence of layer access units that consists, in decoding order, of a CLVS layer access unit, followed by zero or more layer access units that are not CLVS layer access units, including all subsequent layer access units up to but not including any subsequent layer access unit that is a CLVS layer access unit.

In VVC, layers may be coded independently or dependently from each other. When the layers are coded independently, a layer with e.g. nuh_layer_id 0 may not predict video data from another layer with e.g. nuh_layer_id 1. In VVC, dependent coding between layers may be used, which enables support for scalable coding with SNR, spatial and view scalability.

### Intra Random Access Point (IRAP) Pictures and the Coded Video Sequence (CVS)

For single scalability layer coding in HEVC, an access unit (AU) is the coded representation of a single picture. An AU may consist of several video coding layer (VCL) NAL units as well as non-VCL NAL units.

An intra random access point (IRAP) picture in HEVC is a picture that does not refer to any pictures other than itself for prediction in its decoding process. The first picture in the bitstream in decoding order in HEVC must be an IRAP picture but an IRAP picture may additionally also appear later in the bitstream. HEVC specifies three types of IRAP pictures, the broken link access (BLA) picture, the instantaneous decoder refresh (IDR) picture and the clean random access (CRA) picture.

A coded video sequence (CVS) in HEVC is a sequence of access units starting at an IRAP access unit followed by zero or more AUs up to, but not including the next IRAP access unit in decoding order.

In VVC, a CVS is a sequence of access units starting at a CVS start (CVSS) access unit followed by zero or more AUs up to, but not including the next CVSS access unit in decoding order. A CVSS access unit may contain an IRAP picture, i.e., an IDR or a CRA picture, or a gradual decoding refresh (GDR) picture. A CVS may contain one or more coded layer video sequences (CLVSs).

### Slices and Tiles

The concept of slices in HEVC divides the picture into independently coded slices, where decoding of one slice in a picture is independent of other slices of the same picture. Different coding types could be used for slices of the same picture, i.e. a slice could either be an I-slice, P-slice or B-slice. One purpose of slices is to enable resynchronization in case of data loss. In HEVC, a slice is a set of CTUs.

The VVC and HEVC video coding standards includes a tool called tiles that divides a picture into rectangular spatially independent regions. Tiles in VVC are similar to the tiles used in HEVC. Using tiles, a picture in VVC can be partitioned into rows and columns of CTUs where a tile is an intersection of a row and a column.

In VVC, a slice is defined as an integer number of complete tiles or an integer number of consecutive complete CTU rows within a tile of a picture that are exclusively contained in a single NAL unit. In VVC, a picture may be partitioned into either raster scan slices or rectangular slices. A raster scan slice consists of a number of complete tiles in raster scan order. A rectangular slice consists of a group of tiles that together occupy a rectangular region in the picture or a consecutive number of CTU rows inside one tile. Each slice has a slice header comprising syntax elements. Decoded slice header values from these syntax elements are used when decoding the slice. Each slice is carried in one VCL NAL unit. In an early draft of the VVC specification, slices were referred to as tile groups.

### Picture Order Count (POC)

Pictures in HEVC are identified by their picture order count (POC) values, also known as full POC values. Each slice contains a code word, pic_order_cnt_lsb, that shall be the same for all slices in a picture. pic_order_cnt_lsb is also known as the least significant bits (lsb) of the full POC since it is a fixed-length code word and only the least significant bits of the full POC is signaled. Both encoder and decoder keep track of POC and assign POC values to each picture that is encoded/decoded. The pic_order_cnt_lsb can be signaled by 4-16 bits. There is a variable MaxPicOrderCntLsb used in HEVC which is set to the maximum pic_order_cnt_lsb value plus 1. This means that if 8 bits are used to signal pic_order_cnt_lsb, the maximum value is 255 and MaxPicOrderCntLsb is set to 2\hat{ }8=256. The POC value of a picture is called PicOrderCntVal in HEVC. Usually, PicOrderCntVal for the current picture is simply called PicOrderCntVal.

### Reference Picture Management

Reference picture management in HEVC is done using reference pictures sets (RPS). The reference picture set is a set of reference pictures that is signaled in the slice headers. When the decoder has decoded a picture, it is put together with its POC value in a decoded picture buffer (DPB). When decoding a subsequence picture, the decoder parses the RPS syntax from the slice header and constructs lists of reference picture POC values.

The reference picture management in the VVC specification differ slightly from the one in HEVC. In HEVC, the RPS is signaled and the reference picture lists to use for Inter prediction is derived from the RPS. In the VVC specification, the reference pictures lists (RPL) are signaled and the RPS is derived. However, in both specifications, signaling of what pictures to keep in the DPB, what pictures should be short-term and long-term is done. Using POC for picture identification and determination of missing reference pictures is done the same in both specifications.

### Parameter Sets

HEVC and VVC specifies three types of parameter sets, the picture parameter set (PPS), the sequence parameter set (SPS) and the video parameter set (VPS). The PPS contains data that is common for a whole picture, the SPS contains data that is common for a coded video sequence (CVS) and the VPS contains data that is common for multiple CVSs, e.g. data for multiple scalability layers in the bitstream.

VVC also specifies one additional parameter set, the adaptation parameter set (APS). The APS carries parameters needed for the adaptive loop filter (ALF) tool, the luma mapping and chroma scaling (LMCS) tool and the scaling list tool.

Both HEVC and VVC allow certain information (e.g. parameter sets) to be provided by external means. “By external means” should be interpreted as the information is not provided in the coded video bitstream but by some other means not specified in the video codec specification, e.g. via metadata possibly provided in a different data channel, as a constant in the decoder, or provided through an API to the decoder.

### Picture Header

In VVC, a coded picture contains a picture header structure. The picture header structure contains syntax elements that are common for all slices of the associated picture. The picture header structure may be signaled in its own non-VCL NAL unit with NAL unit type PH_NUT or included in the slice header given that there is only one slice in the coded picture. This is indicated by the slice header syntax element picture_header_in_slice_header_flag, where a value equal to 1 specifies that the picture header structure is included in the slice header and a value equal to 0 specifies that the picture header structure is carried in its own PH NAL unit. For a CVS where not all pictures are single-slice pictures, each coded picture must be preceded by a picture header that is signaled in its own NAL unit. HEVC does not support picture headers.

### SEI Messages

Supplementary Enhancement Information (SEI) messages are codepoints in the coded bitstream that do not influence the decoding process of coded pictures from VCL NAL units. SEI messages usually address issues of representation/rendering of the decoded bitstream. The overall concept of SEI messages and many of the messages themselves have been inherited from the H.264 and HEVC specifications into the VVC specification. In VVC, an SEI NAL unit contains one or more SEI messages.

SEI messages assist in processes related to decoding, display or other purposes. However, SEI messages are not required for constructing the luma or chroma samples by the core decoding process. The main use of many SEI messages is to further process one or more pictures that are output by the core decoding process. Some SEI messages are required for checking bitstream conformance and for output timing decoder conformance. Other SEI messages are not required for checking bitstream conformance. A decoder is not required to support all SEI messages. Usually, if a decoder encounters an unsupported SEI message, it is discarded.

ITU-T H.274|ISO/IEC 23002-7, also referred to as VSEI, specifies the syntax and semantics of VUI parameters and SEI messages and is particularly intended for use with VVC, although it is written in a manner intended to be sufficiently generic that it may also be used with other types of coded video bitstreams. The first version of ITU-T H.274|ISO/IEC 23002-7 was finalized in July 2020. At the time of writing, version 3 is under development, which is expected to include several new SEI messages. The latest draft of VSEI version 3 is JVET-AC2032-v2.

### The NN Post-Filter Characteristics SEI Message

One of the new SEI messages expected in a future VSEI v3 specification is the neural network post-filter characteristics (NNPFC) SEI message. The NNPFC SEI message specifies a neural network that may be used as a post-processing filter. The neural network parameters, i.e., the weights of the neural network, may be carried with the NNPFC SEI message. Alternatively, the NNPFC SEI message includes an URI for identifying the neural network. The NNPFC SEI message also includes parameters for describing the characteristics of the neural network, including information about the input to the NN, output from the NN and the purpose of the NN post filter.

The most relevant syntax element and semantics in NNPFC in JVET-AC2032-v2 is reproduced below.

### —Start JVET-AC2032-v2 Text—

### 8.28.1 Neural-Network Post-Filter Characteristics SEI Message Syntax

. . .

| | Descriptor |
|---|---|
| nn_post_filter_characteristics( payloadSize ) { | |
| ... | |
| /* input and output formatting */ | |
| nnpfc_num_input_pics_minus1 | ue(v) |
| ... | |

### 8.28.2 Neural-Network Post-Filter Characteristics SEI Message Semantics

. . .

nnpfc_num_input_pics_minus1 plus 1 specifies the number of decoded output pictures used as input for the NNPF. The value of nnpfc_num_input_pics_minus1 shall be in the range of 0 to 63, inclusive. When nnpfc_purpose & 0x08 is not equal to 0, the value of nnpfc_num_input_pics_minus1 shall be greater than 0.

### —End JVET-AC2032-v2 Text—

### VVC Usage of the NN Post-Filter Characteristics SEI Message

In addition to a new version of VSEI, an update to the VVC specification to support new SEI messages in VVC has been prepared. The most recent version of this VVC update is document JVET-AC2005-v1 and the most relevant part of this document for this invention is as follows:

### —Start JVET-AC2005-v1 Text—

### D.12.11 Use of the Neural Network Post-Filter Characteristics SEI Message

. . .

Let currCodedPic be the coded picture for which the neural-network post-processing filter (NNPF) defined by the neural-network post-filter characteristics (NNPFC) SEI message is activated by a neural-network post-filter activation (NNPFA) SEI message.

The variable pictureRateUpsamplingFlag is set equal to (nnpfc_purpose & 0x08)!=0.

The variable numInputPics is set equal to nnpfc_num_input_pics_minus1+1. The array inputPicPoc[i] for all values of i in the range of 0 to numInputPics−1, inclusive, specifying the picture order count values of the input pictures for the NNPF, is derived as follows:

```
inputPicPoc[ 0 ] is set equal to PicOrderCntVal of currCodedPic.
When numInputPics is greater than 1, the following applies for each value of i in the
  range of 1 to numInputPics − 1, inclusive, in increasing order of i:
    If currCodedPic is associated with a frame packing arrangement SEI message
      with fp_arrangement_type equal to 5 and a particular value of
      fp_current_frame_is_frame0_flag, inputPicPoc[ i ] is set equal to
      PicOrderCntVal of the picture that precedes, in output order, the picture
      associated with index i − 1 and is associated with a frame packing
      arrangement SEI message with fp_arrangement_type equal to 5 and the
      same value of fp_current_frame_is_frame0_flag.
    Otherwise (currCodedPic is not associated with a frame packing arrangement
      SEI message with fp_arrangement_type equal to 5), inputPicPoc[ i ] is set
      equal to PicOrderCntVal of the picture that precedes, in output order, the
      picture associated with index i − 1.
```

### —End JVET-AC2005-v1 Text—

JVET-AC2005-v1 specifies how the array inputPicPoc[i] is constructed. This array specifies the input pictures that may be used by the neural-network post-processing filter.

### SUMMARY

Certain challenges presently exist. For instance, the current methods for signaling information indicating the pictures to use for a post filtering operation (a.k.a., the “post-filter input pictures”) are not robust to picture loss. For example, JVET-AC2005-v1 specifies that the input pictures for the NNPF are identified based on their order of output from the decoder such that a lost coded picture may not be detected. A picture loss may be the result of, for example, temporal layer removal, removal of a non-reference picture, or a loss of data during transmission of the bitstream. If a post-filter input picture is lost, there will be a mismatch between the post-filter input pictures used by an encoder (or selected by the encoder) and the post-filter input pictures used by a receiving device (e.g., a decoder within the receiving device), and this mismatch may not be possible to detect by the receiving device.

Accordingly, in one aspect there is provided a method performed by a receiving device. The method includes receiving a bitstream comprising a first set of coded pictures. The method also includes decoding the first set of coded pictures to produce a set of decoded output pictures, wherein i) each decoded output picture in the set of decoded output pictures has a unique picture identifier value and ii) the set of decoded output pictures comprises a current picture and a set of preceding pictures, where each preceding picture in the set of preceding pictures precedes, in an output order, the current picture. The method also includes obtaining from the bitstream a message associated with the current picture, wherein i) the message relates to a post-filtering of a set of two or more intended input pictures, where the set of intended input pictures comprises the current picture (in one embodiment, all intended input pictures other than the current picture precede the current picture in output order) and ii) the message comprises information for enabling the receiver to determine whether or not the receiver has all of the intended input pictures (e.g., determine whether or not the set of decoded output pictures comprises all of the intended input pictures).

In another embodiment, the method performed by the receiving device includes receiving a bitstream comprising a first coded picture. The method also includes decoding the first coded picture to produce a first decoded picture. The method also includes obtaining metadata for the first decoded picture, where the metadata comprises: i) an output order value for the first decoded picture and ii) an output order value for a particular picture that is intended to precede the first decoded picture in a decoding order. The method also includes adding to a set of output order values the output order value for the first decoded picture wherein the set of output order values comprises output order values of coded pictures in the bitstream that preceded the first coded picture in decoding order. The method also includes determining whether the set of output order values includes an output order value equal to the output order value for the particular picture.

In another aspect there is provided a method performed by an encoder apparatus. The method includes encoding a first intended input picture and a second intended picture to produce a first coded picture and a second coded picture, respectively. The method also includes including the first coded picture and the second coded picture in a bitstream. The method also includes including a message in the bitstream. The message relates to a post-filtering of a set of two or more intended input pictures, where the set of intended input pictures comprises the first intended input picture and the second intended input picture, and the message comprises information for enabling a receiver of the bitstream to determine whether or not the receiver has all of the intended input pictures.

In another aspect there is provided an apparatus that is configured to perform the methods disclosed herein. The apparatus may include memory and processing circuitry coupled to the memory.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium.

An advantage of embodiments disclosed herein is that they enable a receiver to detect whether the input pictures to a post-filter are the intended pictures, thereby improving picture quality.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 is a schematic block diagram of an encoder according to an embodiment.

FIG. 3 is a schematic block diagram of a decoder according to an embodiment.

FIG. 4 illustrates a post filtering process according to an embodiment.

FIG. 5 illustrates a post filtering process according to an embodiment.

FIG. 6 is a flowchart illustrating a process according to an embodiment.

FIG. 7 is a flowchart illustrating a process according to an embodiment.

FIG. 8 is a flowchart illustrating a video encoding process according to an embodiment.

FIG. 9 is a block diagram of an apparatus according to an embodiment.

### DETAILED DESCRIPTION

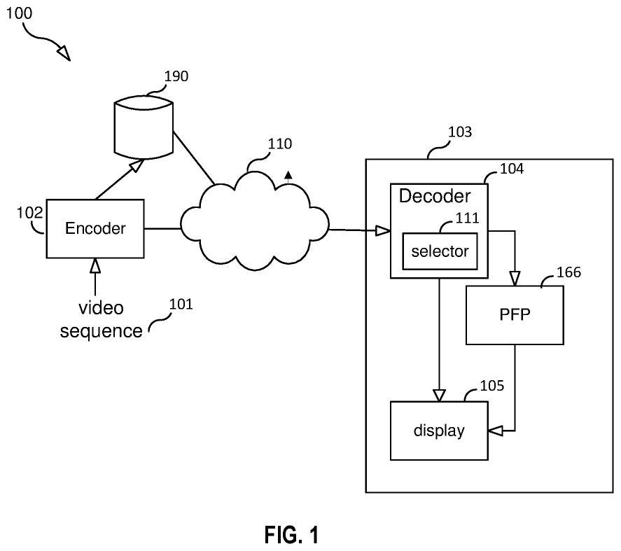

FIG. 1 illustrates a system 100 according to an embodiment. System 100 includes an encoder 102 and a decoder 104, wherein encoder 102 is in communication with decoder 104 via a network 110 (e.g., the Internet or other network). In one embodiment, encoder 102 encodes a video sequence 101 into a bitstream comprising an encoded video sequence and transmits the bitstream to decoder 104 via network 110. In some embodiments, rather than transmitting the bitstream to decoder 104, the bitstream is stored in a data storage unit 190 and decoder 104 retrieves from the data storage unit the bitstream containing the encoded video sequence. Data storage unit 190 may be co-located with encoder 102 or may be remote from encoder 102. Decoder 104 decodes the encoded video sequence to produce video data for display and/or post processing. Decoder 104 may be part of a receiving device 103 either having a display device 105 or connected to a display device. The receiving device 103 may be a mobile device, a set-top device, a television, a transcoding device, a head-mounted display, or any other device. Additionally, as shown in FIG. 1, receiving device 103 may include a post-filter processor (PFP) 166 that may receive one or more decoded output pictures from decoder 104 and that may process the picture(s) using a specified post-filter, such as a neural network (NN) for performing post-filter processing. In the embodiment shown, PFP 166 is separate from decoder 104, but in other embodiments, PFP 166 may be a component of decoder 104.

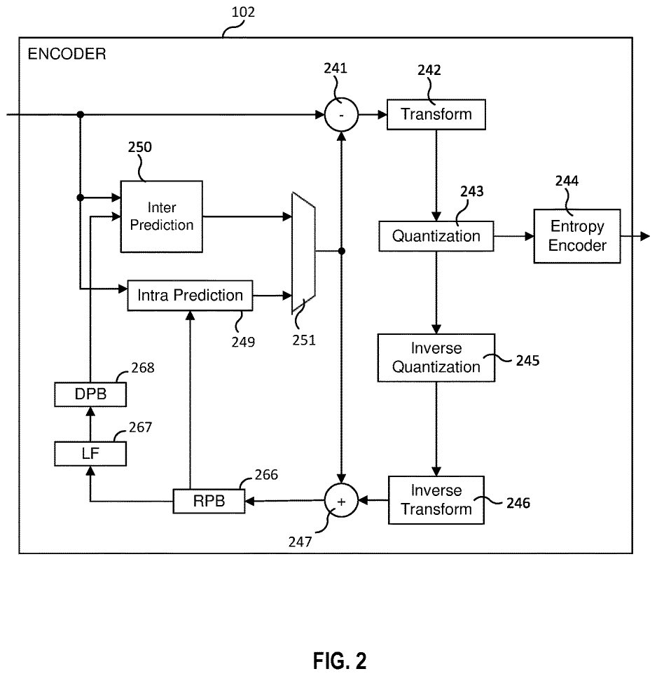

FIG. 2 illustrates functional components of encoder 102 according to some embodiments. It should be noted that encoders may be implemented differently so implementation other than this specific example can be used. Encoder 102 employs a subtractor 241 to produce a residual block which is the difference in pixel values between an input block and a prediction block (i.e., the output of a selector 251, which is either an inter prediction block output by an inter predictor 250 (a.k.a., motion compensator) or an intra prediction block output by an intra predictor 249). Then a forward transform 242 and forward quantization 243 is performed on the residual block as well known in the current art. This produces transform coefficients which are then encoded into the bitstream by encoder 244 (e.g., an entropy encoder) and the bitstream with the encoded transform coefficients is output from encoder 102. Next, encoder 102 uses the transform coefficients to produce a reconstructed block. This is done by first applying inverse quantization 245 and inverse transform 246 to the transform coefficients to produce a reconstructed residual block and using an adder 247 to add the prediction block to the reconstructed residual block, thereby producing the reconstructed block, which is stored in the reconstruction picture buffer (RPB) 266. Loop filtering by a loop filter (LF) stage 267 is applied and the final decoded picture is stored in a decoded picture buffer (DPB) 268, where it can then be used by the inter predictor 250 to produce an inter prediction block for the next picture to be processed. LF stage 267 may include one or more sub-stages, including: i) a deblocking filter, ii) an SAO filter, iii) an ALF, and/or iv) an LMCS filter.

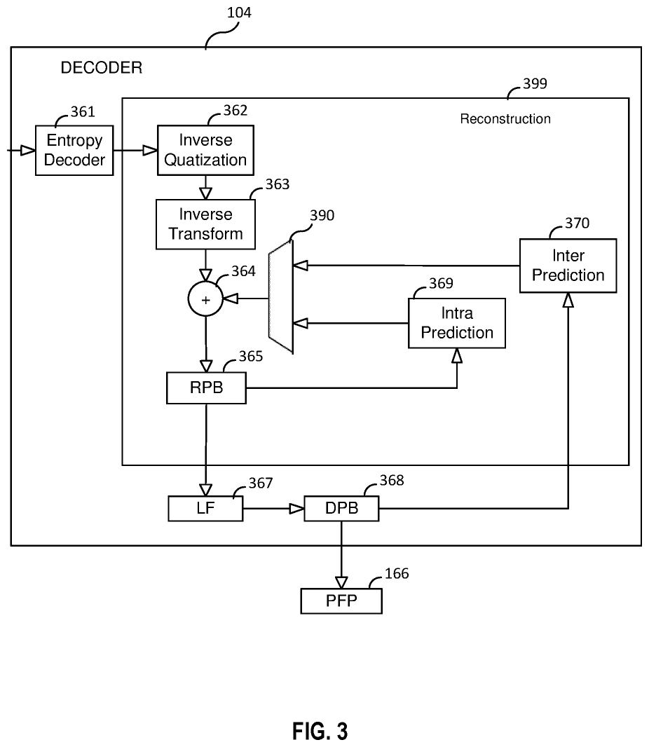

FIG. 3 illustrates functional components of decoder 104 according to some embodiments. It should be noted that decoder 104 may be implemented differently so implementations other than this specific example can be used. Decoder 104 includes a decoder module 361 (e.g., an entropy decoder) that decodes from the bitstream transform coefficient values of a block. Decoder 104 also includes a reconstruction stage 399 in which the transform coefficient values are subject to an inverse quantization process 362 and inverse transform process 363 to produce a residual block. This residual block is input to adder 364 that adds the residual block and a prediction block output from selector 390 to form a reconstructed block. Selector 390 either selects to output an inter prediction block or an intra prediction block. The reconstructed block is stored in a reconstructed picture buffer (RPB) 365. The inter prediction block is generated by the inter prediction module 370 and the intra prediction block is generated by the intra prediction module 369. Following the reconstruction stage 399, a loop filter stage 367 applies loop filtering and the final decoded picture may be stored in a decoded picture buffer (DPB) 368 and output to PFP 166. Pictures are stored in the DPB for two primary reasons: 1) to wait for picture output and 2) to be used for reference when decoding future pictures.

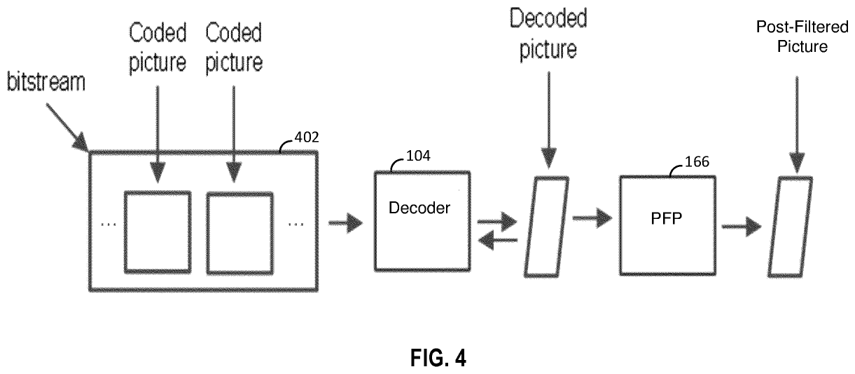

FIG. 4 illustrates a post filtering process according to an embodiment. As shown in FIG. 4, decoder 104 receives a bitstream 402 that includes a set of coded pictures. A coded picture is a picture in coded format, typically a compressed representation of a picture. There may be presentation time stamps and/or POC value for each coded picture encoded into the bitstream, and the output order is then the order of pictures in increasing POC value order (i.e., a first picture having a lower POC value than a second picture will precede, in output order, the second picture). The output from decoder 104 is one or more decoded pictures. Some or all decoded pictures are input to PFP 166, which outputs one or more post-filtered pictures. Some decoded pictures are stored by decoder 104 in DPB 368 to be used for prediction of other pictures during the decoding process, this is indicated by the double arrow in FIG. 4. In one embodiment, the post-filtered pictures produced by PFP 166 are not used in any decoding process of other pictures. The post-filter employed by PFP 166 for post-processing the decoded pictures may be a neural-network based post-filter.

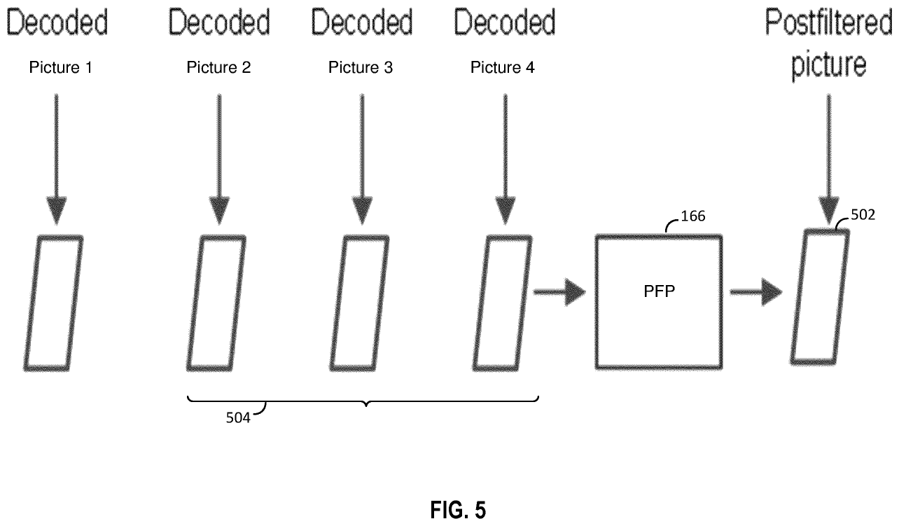

FIG. 5 shows an example of a post-filter process that produces a single output picture 502 from a set of post-filter input pictures 504, which, in this example consists of decoded pictures 4, 3, and 2. In one embodiment, the identity of the input pictures to the PFP 166 is handled by a list of input pictures. The decoded pictures are shown in output order with: picture 1 preceding, in output order, picture 2; picture 2 preceding, in output order, picture 3; picture 3 preceding, in output order, picture 4. In this example, PFP 166 uses three decoded pictures as input and the encoder intends that decoded pictures 4, 3, 2 are the three input pictures. This means that the length of the list of input pictures is equal to 3 and the encoder may encode this length value into a length syntax element in the bitstream 402. In one embodiment, decoder 104 decodes the length syntax element from the bitstream and then constructs an ordered list of input pictures such that the list contains indicators or identifiers to the decoded pictures 4, 3, and 2.

As noted above, certain challenges presently exist due to the fact that the current methods for signaling what input pictures to use for post filtering are not robust to picture loss. That is, if a picture is lost, there may be a mismatch between the post-filter input pictures used by an encoder and the post-filter input pictures used by a receiving device (e.g., a decoder within the receiving device), and this mismatch may not be possible to detect by the receiving device. Note that picture loss here includes intentional removal of coded pictures from the bitstream such as removal of a non-reference picture, or removal of a temporal layer from the bitstream.

Accordingly, this disclosure proposes methods that enable checking that the input pictures to use for post filtering by the receiving device are correct. The proposed methods are constructed so that any loss of picture can be detected by the receiving device. In one embodiment, a new syntax element is introduced to enable a receiving device to detect any mismatch with a video encoder regarding identification of the post-filter input pictures (e.g., the decoded output pictures to use as input to the PFP).

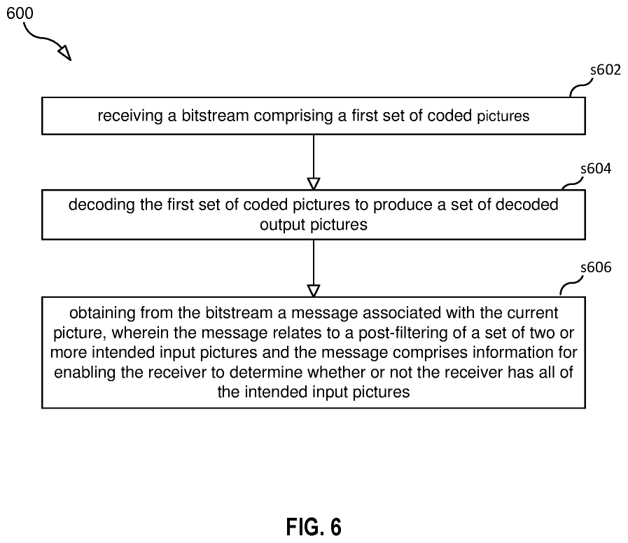

FIG. 6 is a flowchart illustrating a process 600, according to some embodiments which may be performed by device 103 (e.g., some or all of the steps may be performed by decoder 104). Process 600 may begin in step s602. Step s602 comprises receiving a bitstream comprising a first set of coded pictures. Step s604 comprises decoding the first set of coded pictures to produce a set of decoded output pictures, wherein i) each decoded output picture in the set of decoded output pictures has a unique picture identifier value and ii) the set of decoded output pictures comprises a current picture and a set of preceding pictures, where each preceding picture in the set of preceding pictures precedes, in an output order, the current picture. Step s606 comprises obtaining from the bitstream a message associated with the current picture, wherein i) the message relates to a post-filtering of a set of two or more intended input pictures, where the set of intended input pictures comprises the current picture and ii) the message comprises information for enabling the receiver to determine whether or not the receiver has all of the intended input pictures. In one embodiment, determining whether or not the receiver has all of the intended input pictures comprises determining whether or not the set of decoded output pictures comprises all of the intended input pictures.

In some embodiments, the information for enabling the receiver to determine whether or not the receiver has all of the intended input pictures comprises a picture identifier difference value, Diff.

In some embodiments, process 600 further comprises the receiver determining whether or not it has all of the intended input pictures, determining whether or not the receiver has all of the intended input pictures comprises determining whether Diff is equal to (PicIdVal_x−PicIdVal_y−c), where c is a pre-defined number, PicIdVal_x is the picture identifier value of one of the decoded output pictures in the set of decoded output pictures, and PicIdVal_y is the picture identifier value of another one of the decoded output pictures in the set of decoded output pictures, wherein said another one of the decoded output pictures precedes, in output order, said one of the decoded output pictures.

In some embodiments, PicIdVal_x is the picture identifier value of the current picture.

In some embodiments, PicIdVal_y is the picture identifier value of the preceding picture that immediately precedes, in the output order, the current picture.

In some embodiments, PicIdVal_y is the picture identifier value of the picture in the set of intended input pictures that precedes, in output order, any other picture in the set of intended input pictures.

In some embodiments, the information for enabling the receiver to determine whether or not the receiver has all of the intended input pictures further comprises a second picture identifier difference value, Diff2, and determining whether or not the receiver has all of the intended input pictures further comprises determining whether Diff2 is equal to (PicIdVal_y−PicIdVal_z−c), where PicIdVal_z is the picture identifier value for the preceding picture that immediately precedes, in the output order, the preceding picture associated with PicIdVal_y.

In some embodiments, obtaining a value, L, specifying the total number of intended input pictures included in the set of intended input pictures; setting input[0] equal to PicIdVal_x; and for i=1 to L−1, setting input[i] equal to the picture identifier value for the preceding picture that immediately precedes the picture associated with the value of input[i−1]. PicIdVal_y may be equal to the value of input[L−1].

In some embodiments, as a result of determining that Diff≠PicIdVal_x−PicIdVal_y−c, concluding that the receiver does not have all of the intended input pictures.

In some embodiments, the information for enabling the receiver to determine whether or not the receiver has all of the intended input pictures comprises an array of J difference values (i.e., diff[j] for j=0 to j=(J−1)), wherein J is the total number of intended input pictures included in the set of intended input pictures minus 1.

In some embodiments, process 600 further comprises: setting a variable input[0] equal to the picture identifier value of the current picture; and for j=1 to J, setting input[j] equal to input[j−1]−(diff[j−1]+1).

In some embodiments, determining whether or not the receiver has all of the intended input pictures comprises determining whether input[1] is equal to the picture identifier value of the preceding picture that immediately precedes, in output order, the current picture.

In some embodiments, the post-filter is a neural network based post-filter.

In some embodiments, process 600 further comprises using one or more pictures in the set of intended input pictures as input to the post-filter, running the post-filter, and thereby producing at least one post-filtered output picture.

In some embodiments, the message is a NAL unit.

In some embodiments, the NAL unit is a non-VCL NAL unit, or the NAL unit is a VCL NAL unit.

In some embodiments, the NAL unit is a non-VCL NAL unit containing an SEI message or a parameter set that contains the information for enabling the receiver to determine whether or not the receiver has all of the intended input pictures.

### Additional Details

In one embodiment, the post-filter input pictures are specified by receiving device 103 using an ordered list of decoded output pictures (or “decoded pictures” for short). This list identifies the post-filter input pictures. In one embodiment, the list of decoded pictures is a list of integer values where each integer value identifies a single decoded picture.

In this embodiment, receiving device 103 decodes a set of at least two coded pictures into a set of decoded pictures. The decoded picture in the set of decoded pictures that follows all other pictures in the set in output order is called “the last decoded picture” (e.g., picture 4 from FIG. 5) or “the last picture” for short, and the picture that precedes all other pictures in the set in output order is called “the start decoded picture” or “the start picture” for short.

Furthermore, in this embodiment, the length of the ordered list of input pictures is determined. This could be done by decoding a length syntax element and deriving the length of the ordered list based on the value of the decoded syntax element. Thereafter, the entry values in the list are determined such that one of the entries identifies the last picture and another entry identifies the start picture. An entry syntax element is decoded to compute the entry value that identifies the start picture.

The ordered list of input pictures is exclusively intended to identify the pictures that are input to the post-filter. This means that no other list used for decoding the pictures in the set of coded pictures is re-used, and that the determined length value and entry syntax element value are not used for decoding any picture in the set of coded pictures.

A decoder may perform all or a subset of the following steps for this embodiment:

Step 1: decode a first set of coded pictures from a bitstream, where the first set contains at least a first coded picture and a second coded picture, into a set of decoded pictures containing at least a “last” decoded picture and a “start” decoded picture, where the last decoded picture is the decoded picture that follows, in output order, all other pictures in the set of decoded pictures, and the start decoded picture is the decoded picture that precedes, in output order, all other pictures in the set of decoded pictures.

Step 2: determining a picture identifier value identifying a picture that the encoder intended to be the start picture. This picture identifier value may be the intended start picture's output order value (e.g., the intended start picture's POC value) or the picture identifier value may be a delta value between an identifier value of a picture intended to be the last picture (e.g., the intended last picture's output order value) and the identifier value of the intended start picture. This determining may comprise decoding an entry syntax element in the bitstream.

Step 3: determining the length L of an ordered list of input pictures. The length L may be determined by decoding a syntax element in the bitstream.

Step 4: determining the entry values for the ordered list of input pictures, where the ordered list of input pictures includes the start and last decoded pictures, and the ordered list of input pictures indicates input pictures to a post-filter that may be applied, and the ordered list of input pictures is different from any list used for decoding any picture in the first set. In one embodiment, the decoder determines the first entry value as equal to the picture identifier value for the last decoded picture and determines each subsequent entry value as equal to the picture identifier value that identifies the picture that immediately precedes, in output order, the picture identified by the immediately preceding entry value.

Step 5: Apply the post-filter using the input pictures indicated by the entry values.

The picture identifier value, the length L, and/or the entry values may be decoded from an SEI message, a parameter set, such as VPS, SPS, PPS or APS or a header such as a slice header or a picture header.

In one embodiment, receiving device 103 uses the picture identifier value that identifies the intended start picture to determine whether or not the receiving device 103 has all of the input pictures that the encoder intended to be included in the list. If the picture identifier value identifies the “decoded” start picture (i.e., the start picture obtained by the step 1 decoding step) (e.g., the picture identifier value is equal to the above mentioned entry value associated with the decoded start picture), then the receiving device knows that all intended input pictures have been received and there is no mismatch between encoder and receiving device regarding post-filter input pictures.

On the other hand, if the picture identifier value does not identify the start decoded picture, then the input pictures to the post-filter may not be the same as the encoder intended. This can be seen as a mismatch that could occur e.g., due to removal of non-reference pictures from the bitstream, or removal of temporal layers from the bitstream. The receiving may in this case determine or conclude that one or more of the input pictures intended for the post-filter is missing. Based on this conclusion the receiving device may choose to do one or more of the following: not apply the post-filter, apply the post-filter as an active decision, with the knowledge that the output may not be as intended by the encoder, report the mismatch, and/or request the missing input pictures (e.g. from the encoder).

Referring back to FIG. 5, assume the case where coded picture 2 is not present in the bitstream. It may have been intentionally removed by being a non-reference picture or by belonging to a temporal layer that was removed from the bitstream. Alternatively the coded picture 2 may have been lost due to packet losses. This means that there is no corresponding decoded picture 2. The decoder would still decode the length syntax element as equal to 3, and may construct the ordered list of input pictures such that the list contains indicators or identifiers to the decoded pictures 4, 3, and 1. This would be the result for the embodiment where the decoder determines the entry values for the ordered list of input pictures as equal to the picture identifier values of the L pictures in the set of decoded pictures that are last in output order, as described above. In this scenario, the encoder intended picture 2 to be the “start” picture, but the decoder has determined that picture 1 is the start picture. The two pictures are then not the same picture and from this, the decoder would know that all pictures have not been received.

As noted above, in one embodiment the picture identifier identifying a picture that the encoder intended to be the start picture may be a delta value. Accordingly, in one embodiment, the VVC specification may be extended so that this delta value is included in a nn_post_filter_characteristics SEI message. This embodiment may be implemented by the following modifications where added text is shown by italic text.

### *Start Draft Text*

### Neural-Network Post-Filter Characteristics SEI Message Syntax

| | Descriptor |
|---|---|
| nn_post_filter_characteristics( payloadSize ) { | |
| ... | |
| /* input and output formatting */ | |
| nnpfc_num_input_pics_minus1 | ue(v) |
| if( nnpfc_num_input_pics_minus1 > 0) | |
| nnpfc_delta_pic_identifier_minus1 | ue(v) |
| if( ( nnpfc_purpose & 0x02 ) != 0 ) | |
| nnpfc_out_sub_c_flag | u(1) |
| ... | |

### 8.28.2 Neural-Network Post-Filter Characteristics SEI Message Semantics

. . .
nnpfc_delta_pic_identifier_minus1 plus 1 represents a picture identifier difference value between the current picture and the NNPF input picture that is earliest in output order
. . .

### D.12.11 Use of the Neural Network Post-Filter Characteristics SEI Message

. . .
Let currCodedPic be the coded picture for which the neural-network post-processing filter (NNPF) defined by the neural-network post-filter characteristics (NNPFC) SEI message is activated by a neural-network post-filter activation (NNPFA) SEI message.
The variable pictureRateUpsamplingFlag is set equal to (nnpfc_purpose & 0x08)!=0.
The variable L (a.k.a., “numInputPics”) is set equal to nnpfc_num_input_pics_minus1+1.
The array inputPicPoc[i] for all values of i in the range of 0 to L−1, inclusive, specifying the picture order count values of the input pictures for the NNPF, is derived as follows:
inputPicPoc[0] is set equal to PicOrderCntVal of currCodedPic.
When L is greater than 1, the following applies for each value of i in the range of 1 to L−1, inclusive, in increasing order of i:
If currCodedPic is associated with a frame packing arrangement SEI message with
   fp_arrangement_type equal to 5 and a particular value of
   fp_current_frame_is_frame0_flag, inputPicPoc[i] is set equal to PicOrderCntVal of the picture that precedes, in output order, the picture associated with index i−1 and is associated with a frame packing arrangement SEI message with
   fp_arrangement_type equal to 5 and the same value of
   fp_current_frame_is_frame0_flag;
otherwise (currCodedPic is not associated with a frame packing arrangement SEI message with fp_arrangement_type equal to 5), inputPicPoc[i] is set equal to PicOrderCntVal of the picture that precedes, in output order, the picture associated with index i−1.
nnpfc_delta_pic_identifier_minus1 should be equal to inputPicPoc[0]−inputPicPoc[L−1]−1. If this is not the case, the pictures indicated by the array inputPicPoc[i] may not match the input pictures used by the encoder (i.e., may not match the intended input pictures).

### *End Draft Text*

As described above, the input pictures to the NNPF are currently specified in JVET-AC2005-v1 using the array inputPicPoc[i]. The PicOrderCntVal for the coded picture for which the NNPF is activated is put into the array as the first entry: inputPicPoc[0]. Then the PicOrderCntVal for the N closest preceding pictures in output order are added to the list in decreasing PicOrderCntVal order, where N is signaled as nnpfc_num_input_pics_minus1.

The above conventional design does not specify the input pictures to use by information in the bitstream. This means that the decoder would not detect whether removal of temporal layers or removal of non-reference pictures would affect the input pictures to use. This may cause a mismatch between the encoder and decoder regarding what input pictures to use as input to the filter, without any means for the decoder to detect the mismatch. The above embodiment remedies this problem.

In this embodiment, a decoder may perform all or a subset of the following steps:

Step 1: Determining the coded picture (currCodedPic) for which a post-processing filter is activated.

Step 2: Determining a first picture identifier delta value by decoding a first syntax element, nnpfc_delta_pic_identifier_minus1, in the bitstream. In one variant, the first picture identifier delta value is set equal to nnpfc_delta_pic_identifier_minus1+1.

Step 3: Determining the length (L) of an ordered list of input pictures by decoding a second syntax element, nnpfc_num_input_pics_minus1, in the bitstream. In one version the value of L is set equal to the value of (nnpfc_num_input_pics_minus1+1).

Step 4: Determining the entry values for the ordered list, inputPicPoc[i], for all values of i in the range of 0 to L−1, inclusive, specifying the POC values of the input pictures as follows: i) inputPicPoc[0] is set equal to the POC value of the first coded or decoded picture and ii) when L is greater than 1, the following applies for each value of i in the range of 1 to L−1, inclusive, in increasing order of i: inputPicPoc[i] is set equal to POC value of the picture that immediately precedes, in output order, the picture associated with index i−1.

Step 5: Determining a second identifier delta value by subtracting the value of inputPicPoc[L−1] from inputPicPoc[0] (e.g., calculating inputPicPoc[0] minus inputPicPoc[L−1]).

Step 6: Comparing the first identifier delta value with the second identifier delta value. If the values of the first and second identifier delta value are equal, all intended input pictures have all been received. If the values differ, not all intended input pictures have been received and there may be a mismatch between the input pictures derived by the decoder and the input pictures intended by the encoder.

Step 7: In response to determining that the first identifier delta value is equal to the second identifier delta value, applying the post-filter using pictures identified in inputPicPoc[ ] as input.

Step 8: In response to determining that the first identifier delta value is not equal to the second identifier delta value, refrain from applying the post-filter and/or take some other action.

In another embodiment, all entry values, except the first entry value, in the ordered list of input pictures are determined by the receiving device by decoding a syntax element for each entry value. In this embodiment, the receiving device may perform all or a subset of the following steps:

Step 1: Decode a first set of coded pictures from a bitstream, where the first set contains at least a first and a second coded picture, into a second set of decoded pictures containing at least a first and second decoded picture, where the first decoded picture is the decoded picture that follows, in output order, all other pictures in the second set, and the second decoded picture is the decoded picture that precedes, in output order, all other pictures in the second set.

Step 2: deriving a first picture identification value for the first decoded picture.

Step 3: Determining the length L of an ordered list of input pictures. The length L may be determined by decoding a syntax element in the bitstream.

Step 4: Determining the entry values for the ordered list of input pictures by for each entry i from 0 to L−1 in the ordered list of input pictures, in increasing order of i, do the following: if i is equal to 0, setting the 0'th entry value in the ordered list of input pictures equal to the first picture identification value; and if i is greater than 0, then: decoding a syntax element value for the i'th entry; deriving a derived entry value; and setting the i'th entry equal to the derived entry value, wherein the deriving comprises subtracting the decoded syntax element value from the value of the i−1'th entry. In one embodiment, the decoder determines, for each entry value, whether or not there is a picture in the second set of decoded pictures with a picture identification value that corresponds to the entry value. If the decoder determines that there is no picture in the second set of decoded pictures with a picture identification value that corresponds to the entry value, the decoder determines that there is a mismatch between the encoder and decoder regarding what input pictures to use as input to the filter.

Step 5: Apply a post-filter with the input pictures indicated by the ordered list of input pictures as input

In one embodiment, the VVC specification may be extended so that these L−1 delta values are included in a nn_post_filter_characteristics SEI message. This embodiment may be implemented by the following modifications to the nn_post_filter_characteristics SEI message and the draft text for its usage in VVC where added text is shown by italic text and removed text is shown between double brackets [[ ]].

### *Start Draft Text*

### 8.28.1 Neural-Network Post-Filter Characteristics SEI Message Syntax

| | Descriptor |
|---|---|
| nn_post_filter_characteristics( payloadSize ) { | |
| ... | |
| /* input and output formatting */ | |
| nnpfc_num_input_pics_minus1 | ue(v) |
| for( i = 0; i < nnpfc_num_input_pics_minus1; i++ ) | |
| nnpfc_delta_pic_identifier_minus1[ i ] | ue(v) |
| if( ( nnpfc_purpose & 0x02) != 0 ) | |
| nnpfc_out_sub_c_flag | u(1) |
| ... | |

### 8.28.2 Neural-Network Post-Filter Characteristics SEI Message Semantics

. . .
nnpfc_delta_pic_identifier_minus1[i] plus 1 represents a picture identifier difference value between two NNPF input pictures.
. . .

### D.12.11 Use of the Neural Network Post-Filter Characteristics SEI Message

. . .
Let currCodedPic be the coded picture for which the neural-network post-processing filter (NNPF) defined by the neural-network post-filter characteristics (NNPFC) SEI message is activated by a neural-network post-filter activation (NNPFA) SEI message.
. . .
The array inputPicPoc[i] for all values of i in the range of 0 to L−1, inclusive, specifying the picture order count values of the input pictures for the NNPF, is derived as follows:
inputPicPoc[0] is set equal to PicOrderCntVal of currCodedPic.
When L is greater than 1, the following applies for each value of i in the range of 1 to L−1, inclusive, in increasing order of i:

```
inputPicPoc[i] is set equal to inputPicPoc[i−1] − nnpfc_delta_pic_identifier_minus1[i−1]−
1.
  If currCodedPic is associated with a frame packing arrangement SEI message with
    fp_arrangement_type equal to 5 and a particular value of
    fp_current_frame_is_frame0_flag, inputPicPoc[ i ] [[is set]] should be equal to
    PicOrderCntVal of the picture that precedes, in output order, the picture associated
    with index i − 1 and is associated with a frame packing arrangement SEI message
    with fp_arrangement_type equal to 5 and the same value of
    fp_current_frame_is_frame0_flag;
  otherwise (currCodedPic is not associated with a frame packing arrangement SEI
    message with fp_arrangement_type equal to 5), inputPicPoc[ i ] [[is set]] should be
    equal to PicOrderCntVal of the picture that precedes, in output order, the picture
    associated with index i − 1.
      *End Draft Text*
```

In other words, this disclosure provides an embodiment in which syntax elements are added to the bitstream (e.g., added to Neural-network post-filter characteristics SEI message) for specifying, indirectly, the PicOrderCntVal for each of the L−1 closest preceding pictures. This will enable a decoder to detect any mismatch concerning NNPF input picture identifications.

A decoder may perform all or a subset of the following steps for this embodiment:

Step 1: Determining the coded picture (currCodedPic) for which a post-processing filter is activated.

Step 2: Determining the length L of an ordered list of input pictures by decoding a syntax element, nnpfc_num_input_pics_minus1, in the bitstream. In one version the value of L is set equal to the value of (nnpfc_num_input_pics_minus1+1).

Step 3: Determining the entry values for the ordered list, inputPicPoc[i], for all values of i in the range of 0 to L−1, inclusive, specifying the POC values of the input pictures as follows:

```
inputPicPoc[ 0 ] is set equal to the POC value of the first coded or decoded picture;
If L > 1, then the following applies for each value of i in the range of 1 to L − 1,
inclusive, in increasing order of i:
  inputPicPoc[i] is set equal to:
    inputPicPoc[i − 1] − nnpfc_delta_pic_identifier_minus1[i − 1] − 1.
```

Step 4: Apply the post-filter for the currCodedPic with the input pictures in the ordered list of input pictures as input.

In another embodiment, the entry value syntax elements are used to check for mismatch between the encoder and decoder regarding what input pictures to use as input to the filter, while the entry values in the list are derived based on the set of decoded pictures. In this embodiment, the receiving device may perform all or a subset of the following steps:

Step 1: Decode a first set of coded pictures from a bitstream into a second set of decoded pictures containing at least a first and second decoded picture, where the first decoded picture is the decoded picture that follows, in output order, all other pictures in the second set, and the second decoded picture is the decoded picture that precedes, in output order, all other pictures in the second set.

Step 2: deriving a first picture identification value for the first decoded picture.

Step 3: Determining the length L of an ordered list of input pictures. The length L may be determined by decoding a syntax element in the bitstream.

Step 4: Determining the entry values for the ordered list of input pictures by for each entry i from 0 to L−1 in the ordered list of input pictures, in increasing order of i, do the following: if i is equal to 0, setting the O'th entry value in the ordered list of input pictures equal to the first picture identification value; and if i is greater than 0, then: setting the i'th entry value in the ordered list of input pictures equal to the picture identification value of the picture that precedes, in output order, the picture associated with index i−1.

Step 5: For j from 1 to L−1: 1) decoding a syntax element and determining a decoded picture identification value P[j] from the decoded syntax element and 2) comparing the decoded picture identification value P[j] with the corresponding j'th determined entry value.

Step 6: If the value P[j] is not equal to the corresponding j'th determined entry value, the decoder determines that there is a mismatch between the encoder and decoder regarding what input pictures to use as input to the filter.

Step 7: Apply a post-filter with the input pictures indicated by the ordered list of input pictures as input

In another embodiment, a decoder may perform all or a subset of the following steps:

Step 1: Determining the coded picture (currCodedPic) for which a post-processing filter is activated.

Step 2: Determining the length L of an ordered list of input pictures by decoding a syntax element, nnpfc_num_input_pics_minus1, in the bitstream. In one version the value of L is set equal to the value of (nnpfc_num_input_pics_minus1+1).

Step 3: Determining the entry values for the ordered list, inputPicPoc[i], for all values of i in the range of 0 to L−1, inclusive, specifying the POC values of the input pictures as follows:

```
  inputPicPoc[ 0 ] is set equal to the POC value of the current picture (the picture for
  which the post-processing filter is activated).
  When L is greater than 1, the following applies for each value of i in the range of 1 to L
  − 1, inclusive, in increasing order of i:
      inputPicPoc[ i ] is set equal to:
          the POC value of the picture in a set of decoded pictures that immediately
          precedes, in output order, the picture associated with index i − 1.
In terms of the VVC standard:
    If currCodedPic is associated with a frame packing arrangement SEI message with
        fp_arrangement_type equal to 5 and a particular value of
        fp_current_frame_is_frame0_flag, inputPicPoc[ i ] is set equal to PicOrderCntVal
        of the picture that precedes, in output order, the picture associated with index i − 1
        and is associated with a frame packing arrangement SEI message with
        fp_arrangement_type equal to 5 and the same value of
        fp_current_frame_is_frame0_flag;
    otherwise (currCodedPic is not associated with a frame packing arrangement SEI
        message with fp_arrangement_type equal to 5), inputPicPoc[ i ] is set equal to
        PicOrderCntVal of the picture that precedes, in output order, the picture associated
        with index i − 1.
```

Step 4: For each value j in the range from 1 to L−1, decode a delta value (D[j]) from the bitstream and determine whether D[j] is equal to:

$$inputPicPoc [ j - 1 ] - inputPicPoc [ j ] .$$

If D[j] is not equal to (inputPicPoc[j−1]−inputPicPoc[j]), then an intended input picture is missing. Specifically, the missing picture is the picture having a POC value equal to (inputPicPoc[j−1]−D[j]).

Step 5: Apply the post-filter for the currCodedPic with the input pictures in the ordered list of input pictures as input.

In any previously described embodiment, a message that is associated with the current picture may be a message that is included in the same access unit or picture unit as the current picture. The information in the message could, for example, be present in a slice header or picture header of the current coded picture. Alternatively, the information of the message could be present into an SEI message or a parameter set that is associated with the current picture.

### General Detection of a Missing Picture

In another embodiment, a method for general detection of a coded picture “removed” from the bitstream is disclosed. The reasons for such a picture to have been removed from a bitstream include removal of a layer, removal of a temporal layer, removal of a non-reference picture, and packet loss.

In some video coding specifications, there are mechanisms for detecting the loss of a coded picture that is used for reference by other coded pictures. Examples include the RPS concept in HEVC and the RPL concept in VVC. In both these examples, there are lists constructed from (at least in part) slice header or picture header syntax elements of a current picture, where POC values of the pictures that are used for reference by the current picture are derived. A loss of a picture may be detected if there is no picture in the DPB marked as “used for reference” that matches a POC value in a list that specifies that the corresponding picture is used for reference by the current picture. But such mechanisms may not be able to detect any removal of a picture that was in the original bitstream, for example a removal of a non-reference picture.

In this embodiment, an encoder may encode one (or more) previous source picture into one (or more) previous coded picture in an original bitstream. Then, the encoder encodes a current source picture into a current coded picture in the original bitstream such that the current coded picture follows the previous coded picture in decoding order. Also, the previous coded picture is not used for reference by the current coded picture or any future coded picture, and the previous coded picture is indicated to be output before the current coded picture.

The encoder keeps track of the output order value of the previous coded picture. The encoder includes, into the bitstream and with the current coded picture, information that identifies the previous coded picture.

In this embodiment, a decoder decodes a first bitstream that was created by removing coded pictures from an original bitstream. The first bitstream contains a current coded picture that the decoder decodes into a current decoded picture. The decoder decodes, from the first bitstream and with the current coded picture, information that identifies a first output order value that is earlier than the output order value of the current picture. An output order value may be a POC value.

The decoder keeps track of the output order values for a set of coded pictures that precede the current coded picture in decoding order in the first bitstream. The set of coded pictures includes one old coded picture having an output order value that is earlier than the first output order value. The set includes all coded pictures that follow the old coded picture in decoding order and precede the current coded picture in decoding order.

The decoder compares the first output order value with the tracked output order values of all coded pictures in the set. If there is no picture in the set that has an output order value that is equal to the first output order value, the decoder determines that no coded picture having an output order value equal to the first output order value is included in the first bitstream. The decoder may determine that a coded picture having an output order value equal to the first output order value was included in the original bitstream but that this coded picture is not included in the first bitstream.

A future coded picture may here be a coded picture that follows the current coded picture in decoding order.

In this embodiment, a decoder may perform all or a subset of the following steps:

Step 1: Decode a first set of coded pictures from a bitstream where the first set of coded pictures includes consecutive coded pictures in a decoding order starting from a first coded picture that is the first coded picture in decoding order in the set, to a current coded picture which is the last coded picture in decoding order in the set.

Step 2: For each coded picture in the first set, decode an output order identifier for the coded picture and add the output order identifier for the coded picture to a set of output order identifiers (e.g. add the output order identifier to a list of output order identifiers).

Step 3: Decode, from the bitstream, information with the current coded picture, where the information comprises output order value information that identifies a first output order value, wherein the first output order value is a value that is greater than the output order value for the first coded picture and smaller than the output order value for the current coded picture.

Step 4: Compare the first output order value with each of the output order values in the set of output order values.

Step 5: If there is no output order value in the set of output order values that is equal to the first output order value, the decoder determines that a coded picture having an output order value equal to the first output order value is not present in the bitstream. The decoder may determine that a coded picture having an output order value equal to the first output order value was included in an original bitstream produced by an encoder but that this coded picture is not included in the bitstream. The decoder may determine that this coded picture has been removed from the original bitstream.

In one embodiment, the information with the current coded picture is information that is included in the same access unit or picture unit as the current coded picture. The information could for example be put into a slice header or picture header of the current coded picture. Alternatively, the information could be put into an SEI message or APS NAL unit associated with the current coded picture.

In one embodiment, the information with the current coded picture may include one of the following values associated with the first output order value that provides further information to the decoder about the coded picture that is determined to have been removed from the original bitstream: a layer ID value, a temporal layer ID value, a view ID value, and/or a picture type value. When such a value is included in the information, the decoder decodes the value and associates the value with the coded picture that is determined to have been removed from the original bitstream.

Note that there may or may not be a post filter involved in this General Detection embodiment.

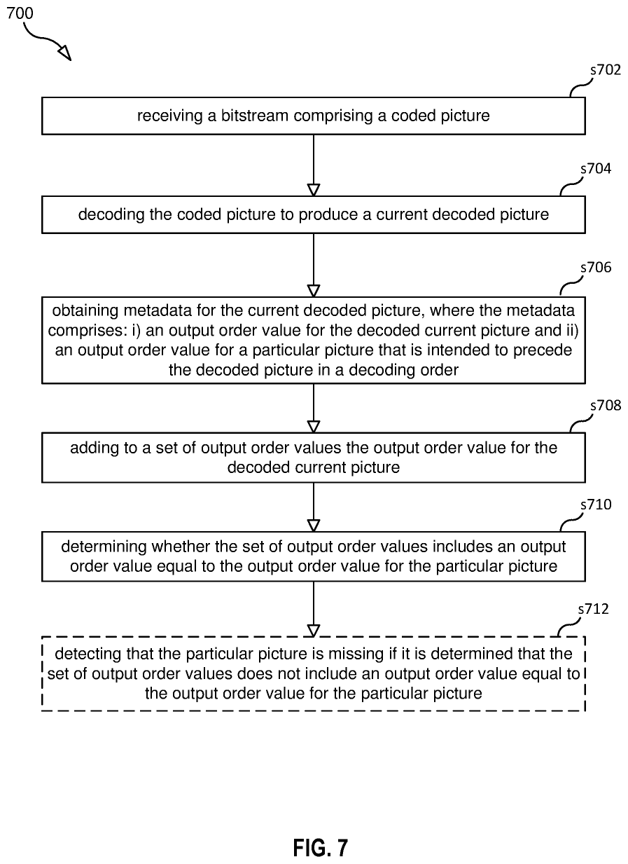

FIG. 7 is a flowchart illustrating a process 700, according to some embodiments which may be performed by device 103 (e.g., some or all of the steps may be performed by decoder 104). Process 700 may begin in step s702.

Step s702 comprises receiving a bitstream comprising a coded picture.

Step s704 comprises decoding the coded picture to produce a current decoded picture.

Step s706 comprises obtaining metadata for the current decoded picture, where the metadata comprises: i) an output order value for the decoded current picture and ii) an output order value for a particular picture that is intended to precede the decoded picture in a decoding order.

Step s708 comprises adding to a set of output order values the output order value for the decoded current picture, wherein the set of output order values comprises output order values from pictures that preceded the coded picture in decoding order.

Step s710 comprises determining whether the set of output order values includes an output order value equal to the output order value for the particular picture.

Step s712 comprises detecting that the particular picture is missing if it is determined that the set of output order values does not include an output order value equal to the output order value for the particular picture.

In some embodiments, process 700 also includes detecting that the particular picture is missing if it is determined that the set of output order values does not include an output order value equal to the output order value for the particular picture.

In some embodiments, the bitstream comprises an access unit or picture unit that comprises the coded picture, and the access unit or picture unit comprises the metadata.

In some embodiments, the access unit or picture unit comprises a header, and the header comprises the output order value for the particular picture.

In some embodiments, the bitstream comprises a NAL unit associated with the coded picture, and the NAL unit comprises the output order value for the particular picture.

In some embodiments, the bitstream further comprises a second coded picture that precedes, in decoding order, the first coded picture; and the method further comprises: prior to decoding the first coded picture, decoding the second coded picture to produce a second decoded picture; obtaining metadata for the second decoded picture, where the metadata for the second decoded picture comprises: i) an output order value for the second decoded picture and ii) an output order value for a second particular decoded picture that is intended to precede the second decoded picture in decoding order; and adding to the set of output order values the output order value for the second decoded picture; and determining whether the set of output order values includes an output order value equal to the output order value for the second particular picture.

In some embodiments, the particular picture is not used for prediction by the first coded picture or any coded picture that follows the first coded picture in decoding order, and/or the particular picture is not used for reference by the first coded picture or any coded picture that follows the first coded picture in decoding order.

In some embodiments, the receiving device manages a decoded picture buffer and the set of output order values consists of the output order values of the pictures that are present in the decoded picture buffer.

In some embodiments, process 700 also includes prior to including in the message the information for enabling the receiver to determine whether or not the receiver has all of the intended input pictures, determining that the set of intended input pictures comprises more than one intended input picture, wherein the information for enabling the receiver to determine whether or not the receiver has all of the intended input pictures is included in the message as a result of determining that the set of intended input pictures comprises more than one intended input picture.

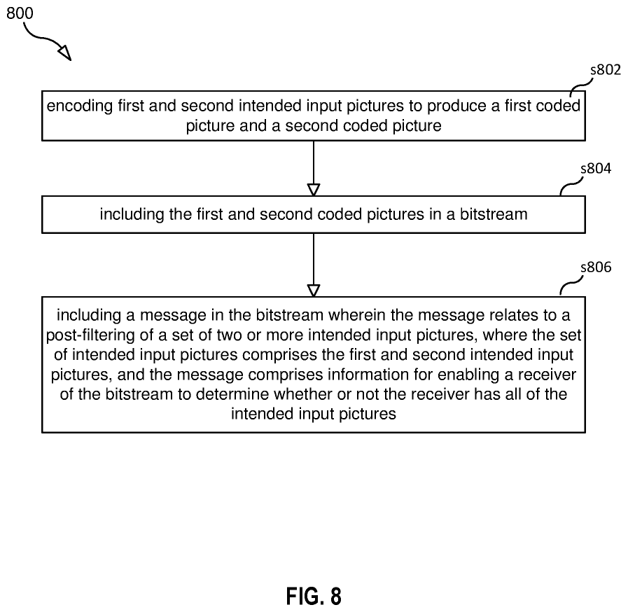

FIG. 8 is a flowchart illustrating a process 800, according to some embodiments which may be performed by device 103 (e.g., some or all of the steps may be performed by decoder 104). Process 800 may begin in step s802.

Step s802 comprises encoding a first intended input picture to produce a first coded picture (a.k.a., encoded picture) and encoding a second intended input picture to produce a second coded picture.

Step s804 comprises including the first coded picture and the second coded picture in a bitstream.

Step s806 comprises including a message in the bitstream, wherein the message relates to a post-filtering of a set of two or more intended input pictures, where the set of intended input pictures comprises the first intended input picture and the second intended input picture, and the message comprises information for enabling a receiver of the bitstream to determine whether or not the receiver has all of the intended input pictures.

In some embodiments, the information for enabling the receiver to determine whether or not the receiver has all of the intended input pictures comprises a picture identifier difference value, Diff.

In some embodiments, Diff is equal to (PicIdVal_x−PicIdVal_y−c), where c is a pre-defined number, PicIdVal_x is a picture identifier value for the first intended input picture, and PicIdVal_y is a picture identifier value for the second intended input picture.

In some embodiments, each intended input picture in the set of intended input pictures other than the first intended input picture, precedes, in output order, the first intended input picture, and the second intended input picture precedes, in output order, all of the other pictures in the set of intended input pictures.

In some embodiments, the second intended input picture immediately precedes, in output order, the first intended input picture.

In some embodiments, the set of intended input pictures further comprises a third intended input picture, the information for enabling the receiver to determine whether or not the receiver has all of the intended input pictures further comprises a second picture identifier difference value, Diff2, Diff2 is equal to (PicIdVal_y−PicIdVal_z−c), where PicIdVal_z is a picture identifier value for the third intended input picture.

In some embodiments, the information for enabling the receiver to determine whether or not the receiver has all of the intended input pictures comprises an array of J difference values (i.e., diff[j] for j−0 to j=(J−1)), wherein J is the total number of intended input pictures included in the set of intended input pictures minus 1.

In some embodiments, the message is Network Abstraction Layer, NAL, unit.

In some embodiments, the NAL unit is a non-VCL NAL unit containing an SEI message or a parameter set that contains the information for enabling the receiver to determine whether or not the receiver has all of the intended input pictures.

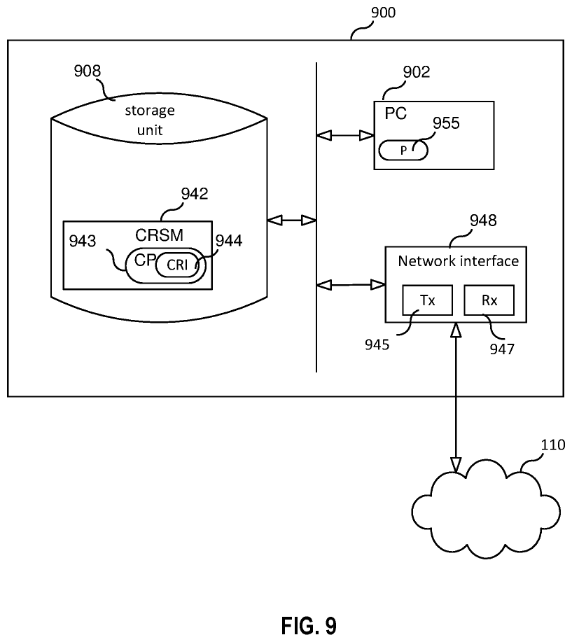

FIG. 9 is a block diagram of an apparatus 900 for implementing encoder 102 and/or receiving device 103, according to some embodiments. When apparatus 900 implements encoder 802, apparatus 900 may be referred to as an encoder apparatus, and when apparatus 900 implements receiving device 103, apparatus 900 may be referred to as a receiver apparatus. As shown in FIG. 9, apparatus 900 may comprise: processing circuitry (PC) 902, which may include one or more processors (P) 955 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 900 may be a distributed computing apparatus); at least one network interface 948 (e.g., a physical interface or air interface) comprising a transmitter (Tx) 945 and a receiver (Rx) 947 for enabling apparatus 900 to transmit data to and receive data from other nodes connected to a network 110 (e.g., an Internet Protocol (IP) network) to which network interface 948 is connected (physically or wirelessly) (e.g., network interface 948 may be coupled to an antenna arrangement comprising one or more antennas for enabling apparatus 900 to wirelessly transmit/receive data); and a storage unit (a.k.a., “data storage system”) 908, which may include one or more non-volatile storage devices and/or one or more volatile storage devices. In embodiments where PC 902 includes a programmable processor, a computer readable storage medium (CRSM) 942 may be provided. CRSM 942 may store a computer program (CP) 943 comprising computer readable instructions (CRI) 944. CRSM 942 may be a non-transitory computer readable medium, such as, magnetic media (e.g., a hard disk), optical media, memory devices (e.g., random access memory, flash memory), and the like. In some embodiments, the CRI 944 of computer program 943 is configured such that when executed by PC 902, the CRI causes apparatus 900 to perform steps described herein (e.g., steps described herein with reference to the flow charts). In other embodiments, apparatus 900 may be configured to perform steps described herein without the need for code. That is, for example, PC 902 may consist merely of one or more ASICs. Hence, the features of the embodiments described herein may be implemented in hardware and/or software.

### Summary of Various Embodiments

A1. A method 600 performed by a receiving device, the method comprising: receiving a bitstream comprising a first set of coded pictures; decoding the first set of coded pictures to produce a set of decoded output pictures, wherein i) each decoded output picture in the set of decoded output pictures has a unique picture identifier value and ii) the set of decoded output pictures comprises a current picture and a set of preceding pictures, where each preceding picture in the set of preceding pictures precedes, in an output order, the current picture; and obtaining from the bitstream a message associated with the current picture, wherein i) the message relates to a post-filtering of a set of two or more intended input pictures, where the set of intended input pictures comprises the current picture (in one embodiment, all intended input pictures other than the current picture precede the current picture in output order) and ii) the message comprises information for enabling the receiver to determine whether or not the receiver has all of the intended input pictures (e.g., determine whether or not the set of decoded output pictures comprises all of the intended input pictures).

A2. The method of embodiment A1, wherein the information for enabling the receiver to determine whether or not the receiver has all of the intended input pictures comprises a picture identifier difference value, Diff.

A3. The method of embodiment A2, further comprising the receiver determining whether or not it has all of the intended input pictures, wherein determining whether or not the receiver has all of the intended input pictures comprises determining whether Diff is equal to (PicIdVal_x−PicIdVal_y−c), where c is a pre-defined number (e.g., c=1 or c=0), PicIdVal_x is the picture identifier value of one of the decoded output pictures in the set of decoded output pictures, and PicIdVal_y is the picture identifier value of another one of the decoded output pictures in the set of decoded output pictures, wherein said another one of the decoded output pictures precedes, in output order, said one of the decoded output pictures.

A4. The method of embodiment A3, wherein PicIdVal_x is the picture identifier value of the current picture.

A4.5. The method of embodiment A4, wherein PicIdVal_y is the picture identifier value of the picture in the set of intended input pictures that precedes, in output order, any other picture in the set of intended input pictures.

A5. The method of embodiment A4, wherein PicIdVal_y is the picture identifier value of the preceding picture that immediately precedes, in the output order, the current picture.

A6. The method of embodiment A5, wherein the information for enabling the receiver to determine whether or not the receiver has all of the intended input pictures further comprises a second picture identifier difference value, Diff2, and determining whether or not the receiver has all of the intended input pictures further comprises determining whether Diff2 is equal to (PicIdVal_y−PicIdVal_z−c), where PicIdVal_z is the picture identifier value for the preceding picture that immediately precedes, in the output order, the preceding picture associated with PicIdVal_y.

A7. The method of any one of embodiments A3-A6, further comprising: obtaining a value, L, specifying the total number of intended input pictures included in the set of intended input pictures; setting input[0] equal to PicIdVal_x; and for i=1 to L−1, setting input[i] equal to the picture identifier value for the preceding picture that immediately precedes the picture associated with the value of input[i−1]. PicIdVal_y may be equal to the value of input[L−1].

A8. The method of any one of embodiments A3, A4, or A5-A7, wherein as a result of determining that Diff≠PicIdVal_x−PicIdVal_y−c, concluding that the receiver does not have all of the intended input pictures.

A9. The method of any one of embodiments A1-A6, wherein the information for enabling the receiver to determine whether or not the receiver has all of the intended input pictures comprises an array of J difference values (i.e., diff[j] for j=0 to j=(J−1)), wherein J is the total number of intended input pictures included in the set of intended input pictures minus 1.

A10. The method of embodiment A9, further comprising: setting a variable input[0] equal to the picture identifier value of the current picture; and for j=1 to J, setting input[j] equal to input[j−1]−(diff[j−1]+1).

A11. The method of embodiment 10, wherein determining whether or not the receiver has all of the intended input pictures comprises determining whether input[1] is equal to the picture identifier value of the preceding picture that immediately precedes, in output order, the current picture.

A12. The method of any of the previous embodiments, wherein the post-filter is a neural network based post-filter.

A13. The method of any previous embodiments, further comprising using one or more pictures in the set of intended input pictures as input to the post-filter, running the post-filter, and thereby producing at least one post-filtered output picture.

A14. The method of any of the previous embodiments, wherein the message is a Network Abstraction Layer, NAL, unit.

A15. The method of embodiment A14, wherein the NAL unit is a non-VCL NAL unit, or the NAL unit is a VCL NAL unit.

A16. The method of embodiment A15, wherein the NAL unit is a non-VCL NAL unit containing an SEI message or a parameter set that contains the information for enabling the receiver to determine whether or not the receiver has all of the intended input pictures.

B1. A method 700 performed by a receiving device, the method comprising: receiving a bitstream comprising a first coded picture; decoding the first coded picture to produce a first decoded picture; obtaining metadata for the first decoded picture, where the metadata comprises: i) an output order value for the first decoded picture and ii) an output order value for a particular picture that is intended to precede the first decoded picture in a decoding order; adding to a set of output order values the output order value for the first decoded picture wherein the set of output order values comprises output order values of coded pictures in the bitstream that preceded the first coded picture in decoding order; and determining whether the set of output order values includes an output order value equal to the output order value for the particular picture.

B2. The method of embodiment B1, further comprising detecting that the particular picture is missing if it is determined that the set of output order values does not include an output order value equal to the output order value for the particular picture.

B3. The method of embodiment B1 or B2, wherein the bitstream comprises an access unit or picture unit that comprises the coded picture, and the access unit or picture unit comprises the metadata.

B4. The method of embodiment B3, wherein the access unit or picture unit comprises a header (e.g., slice header or picture header), and the header comprises the output order value for the particular picture.

B5. The method of embodiment B1 or B2, wherein the bitstream comprises a NAL unit (e.g., SEI message or APS NAL unit) associated with the coded picture, and the NAL unit comprises the output order value for the particular picture.

B6. The method of any one of embodiments B1-B5, wherein the bitstream further comprises a second coded picture that precedes, in decoding order, the first coded picture; and the method further comprises: prior to decoding the first coded picture, decoding the second coded picture to produce a second decoded picture; obtaining metadata for the second decoded picture, where the metadata for the second decoded picture comprises: i) an output order value for the second decoded picture and ii) an output order value for a second particular decoded picture that is intended to precede the second decoded picture in decoding order; and adding to the set of output order values the output order value for the second decoded picture; and determining whether the set of output order values includes an output order value equal to the output order value for the second particular picture.

B7 The method of any one of embodiments B1-B6, wherein the particular picture is not used for prediction by the first coded picture or any coded picture that follows the first coded picture in decoding order, and/or the particular picture is not used for reference by the first coded picture or any coded picture that follows the first coded picture in decoding order.

B8. The method of any one of embodiments B1-B7, wherein the receiving device manages a decoded picture buffer and the set of output order values consists of the output order values of the pictures that are present in the decoded picture buffer.

B9. The method of any one of embodiments B1-B8, further comprising prior to including in the message the information for enabling the receiver to determine whether or not the receiver has all of the intended input pictures, determining that the set of intended input pictures comprises more than one intended input picture, wherein the information for enabling the receiver to determine whether or not the receiver has all of the intended input pictures is included in the message as a result of determining that the set of intended input pictures comprises more than one intended input picture.

C1. A method 800 performed by an encoder apparatus, the method comprising: encoding a first intended input picture and a second intended picture to produce a first coded picture and a second coded picture, respectively; including the first coded picture and the second coded picture in a bitstream; including a message in the bitstream, wherein the message relates to a post-filtering of a set of two or more intended input pictures, where the set of intended input pictures comprises the first intended input picture and the second intended input picture, and the message comprises information for enabling a receiver of the bitstream to determine whether or not the receiver has all of the intended input pictures.

C2. The method of embodiment C1, wherein the information for enabling the receiver to determine whether or not the receiver has all of the intended input pictures comprises a picture identifier difference value, Diff.

C3. The method of embodiment C2, wherein Diff is equal to (PicIdVal_x−PicIdVal_y−c), where c is a pre-defined number (e.g., c=1 or c=0), PicIdVal_x is a picture identifier value for the first intended input picture, and PicIdVal_y is a picture identifier value for the second intended input picture.

C4. The method of embodiment C4, wherein each intended input picture in the set of intended input pictures other than the first intended input picture, precedes, in output order, the first intended input picture, and the second intended input picture precedes, in output order, all of the other pictures in the set of intended input pictures.

C5. The method of embodiment C5, wherein the second intended input picture immediately precedes, in output order, the first intended input picture.

C6. The method of embodiment C5, wherein the set of intended input pictures further comprises a third intended input picture, the information for enabling the receiver to determine whether or not the receiver has all of the intended input pictures further comprises a second picture identifier difference value, Diff2, Diff2 is equal to (PicIdVal_y−PicIdVal_z−c), where PicIdVal_z is a picture identifier value for the third intended input picture.

C7. The method of any one of embodiments C1-C6, wherein the information for enabling the receiver to determine whether or not the receiver has all of the intended input pictures comprises an array of J difference values (i.e., diff[j] for j−0 to j=(J−1)), wherein J is the total number of intended input pictures included in the set of intended input pictures minus 1.

C8. The method of any one of embodiments C1-C7, wherein the message is a Network Abstraction Layer, NAL, unit.

C9. The method of embodiment C8, wherein the NAL unit is a non-VCL NAL unit containing an SEI message or a parameter set that contains the information for enabling the receiver to determine whether or not the receiver has all of the intended input pictures.

E1. A computer program (943) comprising instructions (944) which when executed by processing circuitry (902) of an apparatus (900) causes the apparatus to perform the method of any one of embodiments A1-A16 or B1-B9 or C1-C9.

E2. A carrier containing the computer program of embodiment E1, wherein the carrier is one of an electronic signal, an optical signal, a radio signal, and a computer readable storage medium (942).

F1. An apparatus (900) that is configured to perform the method of any one of embodiments A1-A16 or B1-B9 or C1-C9.

While certain the terminology in this disclosure may be described in terms of VVC, the embodiments of this disclosure also apply to any existing or future codec, which may use a different, but equivalent terminology. Also, the word “a” is intended to be interpreted broadly to mean “one or more” or “at least one,” unless indicated otherwise.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-66. (canceled)

67. A method performed by a receiving device, the method comprising:
receiving a bitstream comprising a first set of coded pictures;
decoding the first set of coded pictures to produce a set of decoded output pictures, wherein i) each decoded output picture in the set of decoded output pictures has a unique picture identifier value and ii) the set of decoded output pictures comprises a current picture and a set of preceding pictures, where each preceding picture in the set of preceding pictures precedes, in an output order, the current picture;
obtaining from the bitstream a message associated with the current picture, wherein i) the message relates to a post-filtering of a set of two or more intended input pictures, where the set of intended input pictures is intended to be used as input to the post-filtering and comprises the current picture and ii) the message comprises information for enabling the receiver to determine whether or not the receiver has all of the intended input pictures, wherein
the information comprises a picture identifier difference value, Diff; and
determining whether or not the receiver has all of the intended input pictures by determining whether or not Diff is equal to (PicIdVal_x−PicIdVal_y−c), where
c is a pre-defined constant,
PicIdVal_x is the picture identifier value of one of the decoded output pictures in the set of decoded output pictures, and
PicIdVal_y is the picture identifier value of another one of the decoded output pictures in the set of decoded output pictures, wherein said another one of the decoded output pictures precedes, in output order, said one of the decoded output pictures, and
wherein determining that Diff #PicIdVal_x−PicIdVal_y−c comprises determining that the receiver does not have all of the intended input pictures.

68. The method of claim 67, wherein
PicIdVal_x is the picture identifier value of the current picture.

69. The method of claim 68, wherein:
PicIdVal_y is the picture identifier value of the preceding picture that immediately precedes, in the output order, the current picture;
the information for enabling the receiver to determine whether or not the receiver has all of the intended input pictures further comprises a second picture identifier difference value, Diff2; and
determining whether or not the receiver has all of the intended input pictures further comprises determining whether Diff2 is equal to (PicIdVal_y−PicIdVal_z−c), where
PicIdVal_z is the picture identifier value for the preceding picture that immediately precedes, in the output order, the preceding picture associated with PicIdVal_y.

70. The method of claim 67, wherein the method further comprises:
obtaining a value, L, specifying the total number of intended input pictures included in the set of intended input pictures;
setting input[0] equal to PicIdVal_x; and
for i=1 to L−1, setting input[i] equal to the picture identifier value for the preceding picture that immediately precedes the picture associated with the value of input[i−1].

71. The method of claim 67, wherein
the information for enabling the receiver to determine whether or not the receiver has all of the intended input pictures comprises an array of J difference values (i.e., diff[j] for j=0 to j=(J−1)), and wherein
J is the total number of intended input pictures included in the set of intended input pictures minus 1.

72. The method of claim 71, wherein the method further comprises:
setting a variable input[0] equal to the picture identifier value of the current picture;
for j=1 to J, setting input[j] equal to input[j−1]−(diff[j−1]+1); and
determining whether or not the receiver has all of the intended input pictures comprises determining whether input[1] is equal to the picture identifier value of the preceding picture that immediately precedes, in output order, the current picture.

73. The method of claim 67, wherein
the post-filter is a neural network based post-filter.

74. The method of claim 67, wherein
the method further comprises using one or more pictures in the set of intended input pictures as input to the post-filter, running the post-filter, and thereby producing at least one post-filtered output picture.

75. The method of claim 67, wherein the message is a non-Video Coding Layer, non-VCL Network Abstraction Layer, NAL unit containing a Supplemental Enhancement Information, SEI message or a parameter set that contains the information for enabling the receiver to determine whether or not the receiver has all of the intended input pictures.

76. A method performed by a receiving device, the method comprising:
receiving a bitstream comprising a first coded picture;
decoding the first coded picture to produce a first decoded picture;
obtaining metadata for the first decoded picture, where the metadata comprises: i) an output order value for the first decoded picture and ii) an output order value for a particular picture that is intended to precede the first decoded picture in a decoding order;
adding to a set of output order values the output order value for the first decoded picture wherein the set of output order values comprises output order values of coded pictures in the bitstream that preceded the first coded picture in decoding order; and
determining whether the set of output order values includes an output order value equal to the output order value for the particular picture.

77. The method of claim 76, further comprising detecting that the particular picture is missing if it is determined that the set of output order values does not include an output order value equal to the output order value for the particular picture.

78. The method of claim 76, wherein
the bitstream comprises an access unit or picture unit that comprises the first coded picture, and
the access unit or picture unit comprises the metadata.

79. The method of claim 78, wherein
the access unit or picture unit comprises a header, and
the header comprises the output order value for the particular picture.

80. The method of claim 76, wherein
the bitstream comprises a NAL unit associated with the coded picture, and
the NAL unit comprises the output order value for the particular picture.

81. The method of claim 76, wherein
the bitstream further comprises a second coded picture that precedes, in decoding order, the first coded picture; and
the method further comprises:
prior to decoding the first coded picture, decoding the second coded picture to produce a second decoded picture;
obtaining metadata for the second decoded picture, where the metadata for the second decoded picture comprises: i) an output order value for the second decoded picture and ii) an output order value for a second particular decoded picture that is intended to precede the second decoded picture in decoding order; and
adding to the set of output order values the output order value for the second decoded picture; and
determining whether the set of output order values includes an output order value equal to the output order value for the second particular picture.

82. The method of claim 76, wherein
the receiving device manages a decoded picture buffer and the set of output order values consists of the output order values of the pictures that are present in the decoded picture buffer.

83. The method of claim 76, further comprising prior to including in the message the information for enabling the receiver to determine whether or not the receiver has all of the intended input pictures, determining that the set of intended input pictures comprises more than one intended input picture, wherein
the information for enabling the receiver to determine whether or not the receiver has all of the intended input pictures is included in the message as a result of determining that the set of intended input pictures comprises more than one intended input picture.

84. An apparatus, the apparatus comprising:
a memory; and
a processor connected to the memory, whereby the processor is configurable to cause the apparatus to:
encode a first intended input picture and a second intended picture to produce a first coded picture and a second coded picture, respectively;
include the first coded picture and the second coded picture in a bitstream; and
include a message in the bitstream, wherein
the message relates to a post-filtering of a set of two or more intended input pictures, where the set of intended input pictures is intended to be used as input to the post-filtering and comprises the first intended input picture and the second intended input picture, and
the message comprises information for enabling a receiver of the bitstream to determine whether or not the receiver has all of the intended input pictures, wherein the information for enabling the receiver to determine whether or not the receiver has all of the intended input pictures comprises a picture identifier difference value, Diff, wherein Diff is equal to (PicIdVal_x−PicIdVal_y−c), where
c is a pre-defined number,
PicIdVal_x is a picture identifier value for the first intended input picture, and
PicIdVal_y is a picture identifier value for the second intended input picture.

85. The apparatus of claim 84, wherein
each intended input picture in the set of intended input pictures other than the first intended input picture, precedes, in output order, the first intended input picture, and
the second intended input picture precedes, in output order, all of the other pictures in the set of intended input pictures.

86. The apparatus of claim 84, wherein
the message is a non-Video Coding Layer, non-VCL Network Abstraction Layer, NAL unit containing a Supplemental Enhancement Information, SEI message or a parameter set that contains the information for enabling the receiver to determine whether or not the receiver has all of the intended input pictures.

87. A carrier containing a computer program comprising instructions which when executed by processing circuitry of an apparatus causes the apparatus to perform the method of claim 67, wherein
the carrier is one of an electronic signal, an optical signal, a radio signal, and a computer readable storage medium.

88. An apparatus, wherein the apparatus comprises:
a memory; and
a processor connected to the memory, whereby the processor is configurable to cause the apparatus to:
receive a bitstream comprising a first set of coded pictures;
decode the first set of coded pictures to produce a set of decoded output pictures, wherein i) each decoded output picture in the set of decoded output pictures has a unique picture identifier value and ii) the set of decoded output pictures comprises a current picture and a set of preceding pictures, where each preceding picture in the set of preceding pictures precedes, in an output order, the current picture;
obtain from the bitstream a message associated with the current picture, wherein i) the message relates to a post-filtering of a set of two or more intended input pictures, where the set of intended input pictures is intended to be used as input to the post-filtering and comprises the current picture and ii) the message comprises information for enabling the receiver to determine whether or not the receiver has all of the intended input pictures, wherein the information comprises a picture identifier difference value, Diff; and
determine whether or not the receiver has all of the intended input pictures by determining whether or not Diff is equal to (PicIdVal_x−PicIdVal_y−c), where
c is a pre-defined constant,
PicIdVal_x is the picture identifier value of one of the decoded output pictures in the set of decoded output pictures, and
PicIdVal_y is the picture identifier value of another one of the decoded output pictures in the set of decoded output pictures, wherein said another one of the decoded output pictures precedes, in output order, said one of the decoded output pictures, and
wherein determining that Diff≠PicIdVal_x−PicIdVal_y−c comprises determining that the receiver does not have all of the intended input pictures.

89. An apparatus, wherein the apparatus comprises:
a memory; and
a processor connected to the memory, whereby the processor is configurable to cause the apparatus to:
receive a bitstream comprising a first coded picture;
decode the first coded picture to produce a first decoded picture;
obtain metadata for the first decoded picture, where the metadata comprises: i) an output order value for the first decoded picture and ii) an output order value for a particular picture that is intended to precede the first decoded picture in a decoding order;
add to a set of output order values the output order value for the first decoded picture wherein the set of output order values comprises output order values of coded pictures in the bitstream that preceded the first coded picture in decoding order; and
determine whether the set of output order values includes an output order value equal to the output order value for the particular picture.
